(19) United States
(12) Patent Application Publication
(10) Pub. No.: US 2021/0374149 A1
(43) Pub. Date: Dec. 2, 2021

(54) SORTING

(71) Applicant: BEIJING SANKUAI ONLINE TECHNOLOGY CO., LTD, Beijing (CN)

(72) Inventors: Sheng ZHU, Beijing (CN); Biao TANG, Beijing (CN); Gong ZHANG, Beijing (CN); Feiyi WANG, Beijing (CN); Zhongyuan WANG, Beijing (CN); Di ZHU, Beijing (CN)

(21) Appl. No.: 17/370,084

(22) Filed: Jul. 8, 2021

Related U.S. Application Data
(63) Continuation of application No. PCT/CN2019/120676, filed on Nov. 25, 2019.

(30) Foreign Application Priority Data
Jan. 10, 2019 (CN) 201910024150.9
Mar. 12, 2019 (CN) 201910191098.6

(51) Int. Cl. G06F 16/2457; G06N 3/08; G06F 16/28

(52) U.S. Cl. CPC G06F 16/24578; G06F 16/285; G06N 3/08

(57) ABSTRACT

A sorting method is provided. The sorting method according to embodiments of the present disclosure includes: performing grouping on a data sample set according to a search request, to obtain at least one search request group; training a neural network model by using the search request group, where during the training of the neural network model, a parameter of the neural network model is adjusted according to current predicted values of clicked candidate objects and unclicked candidate objects in a same search request group and a variation of a normalized discounted cumulative gain (NDCG) before and after rank positions of the clicked candidate object and the unclicked candidate object are exchanged; and sorting, by using the neural network model, target objects associated with a target search term.

This application claims priority to Chinese Patent Application No. 201910024150.9, entitled “SORTING METHOD, APPARATUS, ELECTRONIC DEVICE, AND READABLE STORAGE MEDIUM” filed with the China National Intellectual Property Administration on Jan. 10, 2019 and priority to Chinese Patent Application No. 201910191098.6, entitled “SORTING METHOD, APPARATUS, ELECTRONIC DEVICE, AND READABLE STORAGE MEDIUM” filed with the China National Intellectual Property Administration on Mar. 12, 2019, which are incorporated herein by reference in their entireties.

### TECHNICAL FIELD

Embodiments of the present disclosure relate to the field of search recommendation technologies, and in particular, to a sorting method, an apparatus, an electronic device, and a readable storage medium.

### BACKGROUND

A search recommendation platform may recommend several search results to a user according to a keyword inputted by the user, and the search results need to be sorted before being displayed to the user. Therefore, sorting accuracy directly affects a recommendation result.

In the prior art, deep learning, for example, a deep and wide network (DWN) model, a deep factorization machine (DFM), and a deep and cross network (DCN) model, may be applied to sorting. However, a logarithmic loss function is used in all of the foregoing three models, but the logarithmic loss function cannot accurately represent search results, resulting in relatively poor sorting accuracy of the models obtained through training.

### SUMMARY

Embodiments of the present disclosure provide a sorting method, an apparatus, an electronic device, and a readable storage medium, to resolve the foregoing problems of sorting in the prior art.

The embodiments of the present disclosure provide a sorting method, including:

performing, by one or more processors, grouping on a data sample set according to a search request, to obtain at least one search request group;

training, by the one or more processors, a neural network model by using the search request group, where during the training of the neural network model, a parameter of the neural network model is adjusted according to current predicted values of clicked candidate objects and unclicked candidate objects in a same search request group and a variation of a normalized discounted cumulative gain (NDCG) before and after rank positions of the clicked candidate object and the unclicked candidate object are exchanged; and

sorting, by the one or more processors by using the neural network model, target objects associated with a target search term.

Optionally, the step of adjusting a parameter of the neural network model according to current predicted values of clicked candidate objects and unclicked candidate objects in a same search request group and a variation of an NDCG before and after rank positions of the clicked candidate object and the unclicked candidate object are exchanged includes:

calculating respectively, for the clicked candidate object and the unclicked candidate object in the same search request group, an NDCG when the clicked candidate object is ranked before the unclicked candidate object and an NDCG when the clicked candidate object is ranked after the unclicked candidate object, to obtain a first gain and a second gain;

calculating an absolute value of a difference between the first gain and the second gain;

calculating a difference between the current predicted values of the clicked candidate object and the unclicked candidate object, to obtain a first difference;

calculating a product of the difference and a preset coefficient, to obtain a first product;

calculating an exponent result by using a natural constant as a base and the first product as an exponent, to obtain a first exponent result;

calculating a sum of the exponent result and 1, to obtain a first value;

calculating a product of the preset coefficient and the absolute value, to obtain a second product;

calculating a ratio of the second product to the first value, and calculating an additive inverse of the ratio, to obtain a gradient between the clicked candidate object and the unclicked candidate object; and

adjusting the parameter of the neural network model according to the gradient between the clicked candidate object and the unclicked candidate object.

Optionally, the gradient λ_{i,j} between the clicked candidate object and the unclicked candidate object is calculated according to the following formula:

$${λ}_{i , j} = \frac{- σ \vert {Δ}_{NDCG} \vert}{1 + {e}^{σ ( {S}_{i} - {S}_{j} )}}$$

where σ is a preset coefficient, Sᵢ and Sⱼ are respectively the current predicted values of the clicked candidate object and the unclicked candidate object, and Δ_{NDCG} is the variation of the NDCG before and after the rank positions of the clicked candidate object and the unclicked candidate object are exchanged.

Optionally, the step of adjusting the parameter of the neural network model according to the gradient between the clicked candidate object and the unclicked candidate object includes:

obtaining, for each candidate object, separately another candidate object before a position of the candidate object and another candidate object after the position of the candidate object, to obtain a first object and a second object;

calculating a sum of a gradient of the candidate object and a gradient of the first object, to obtain a first gradient sum;

calculating a sum of the gradient of the candidate object and a gradient of the second object, to obtain a second gradient sum;

calculating a difference between the second gradient sum and the first gradient sum, to obtain an adjustment gradient of the candidate object; and

adjusting a parameter corresponding to the candidate object in the neural network model according to the adjustment gradient.

Optionally, the method further includes:

calculating a loss value according to the current predicted values of the clicked candidate objects and the unclicked candidate objects in the same search request group and a position tag of the candidate objects after each training; and

ending the training in a case that the loss value is less than or equal to a preset loss value threshold.

Optionally, the step of calculating a loss value according to the current predicted values of the clicked candidate objects and the unclicked candidate objects in the same search request group and a position tag of the candidate objects includes:

calculating, for the current predicted values of the clicked candidate objects and the unclicked candidate objects in the same search request group, a difference between 1 and the position tag of the candidate objects, to obtain a second difference; and

calculating, for the current predicted values of the clicked candidate objects and the unclicked candidate objects in the same search request group, a difference between the current predicted values of the clicked candidate object and the unclicked candidate object, to obtain a third difference;

calculating a product of the second difference, the third difference, a preset coefficient, and one half, to obtain a third product;

calculating a product of the third difference and the preset coefficient, and calculating an additive inverse of the ratio, to obtain a fourth product;

calculating an exponent result by using a natural constant as a base and the fourth product as an exponent, to obtain a second exponent result;

calculating a sum of 1 and the second exponent result as a true number, and calculating a logarithm by using 10 as a base, to obtain a logarithm result;

calculating a sum of the third product and the logarithm result, to obtain a first loss value of the clicked candidate object and the unclicked candidate object; and

calculating an average of the first loss value of the clicked candidate object and the unclicked candidate object, to obtain a loss value.

Optionally, the first loss value C_{i,j} of the clicked candidate object and the unclicked candidate object is calculated according to the following formula:

$${C}_{i , j} = \frac{1}{2} ( 1 - {S}_{ij} ) σ ( {S}_{i} - {S}_{j} ) + log ( 1 + {e}^{- σ ( {S}_{i} - {S}_{j} )} )$$

wherein Sᵢⱼ is a difference between tag values of a clicked candidate object and an unclicked candidate object.

Optionally, before the sorting, by using the neural network model, target objects associated with a target search term, the method further includes:

deploying the neural network model obtained through training onto an application platform, so that the application platform invokes the neural network model to sort the target objects associated with the target search term.

The embodiments of the present disclosure further provide an electronic device, including a memory, a processor, and a computer program stored in the memory and executable on the processor, where the processor performs the following operations:

performing grouping on a data sample set according to a search request, to obtain at least one search request group;

training a neural network model by using the search request group, where during the training of the neural network model, a parameter of the neural network model is adjusted according to current predicted values of clicked candidate objects and unclicked candidate objects in a same search request group and a variation of an NDCG before and after rank positions of the clicked candidate object and the unclicked candidate object are exchanged; and

sorting, by using the neural network model, target objects associated with a target search term.

The embodiments of the present disclosure provide a non-volatile computer-readable storage medium, storing computer program code, wherein when the computer program code is executed by an electronic device, the electronic device performs the following operations:

performing grouping on a data sample set according to a search request, to obtain at least one search request group;

training a neural network model by using the search request group, where during the training of the neural network model, a parameter of the neural network model is adjusted according to current predicted values of clicked candidate objects and unclicked candidate objects in a same search request group and a variation of an NDCG before and after rank positions of the clicked candidate object and the unclicked candidate object are exchanged; and

sorting, by using the neural network model, target objects associated with a target search term.

The request, to obtain at least one search request group; training a neural network model by using the search request group, where during the training of the neural network model, a parameter of the neural network model is adjusted according to current predicted values of clicked candidate objects and unclicked candidate objects in a same search request group and a variation of an NDCG before and after rank positions of the clicked candidate object and the unclicked candidate object are exchanged; and sorting, by using the neural network model, target objects associated with a target search term. In the embodiments of the present disclosure, the neural network model may be adjusted with reference to the NDCG, so that an adjustment result is more adapted to the field of search recommendation and helps to improve accuracy of the neural network model.

The foregoing description is merely an overview of the technical solutions of the present disclosure. To understand the present disclosure more clearly, implementation can be performed according to content of the specification. Moreover, to make the foregoing and other objectives, features, and advantages of the present disclosure more comprehensible, specific implementations of the present disclosure are particularly listed below.

### BRIEF DESCRIPTION OF THE DRAWINGS

To describe the technical solutions in embodiments of the present disclosure more clearly, the following briefly describes accompanying drawings required for describing the embodiments of the present disclosure. Apparently, the accompanying drawings in the following description show merely some embodiments of the present disclosure, and a person of ordinary skill in the art can still derive other drawings from these accompanying drawings without creative efforts.

FIG. 1 shows a flowchart of specific steps of a sorting method according to the present disclosure.

FIG. 2 shows a flowchart of specific steps of another sorting method according to the present disclosure.

FIG. 3 illustratively shows a block diagram of an electronic device for performing a method according to the present disclosure.

FIG. 4 illustratively shows a storage unit for maintaining or carrying program code for implementing a method according to the present disclosure.

### DETAILED DESCRIPTION OF THE EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are merely some embodiments of the present disclosure rather than all of the embodiments. All other embodiments obtained by a person of ordinary skill in the art based on the embodiments of the present disclosure without creative efforts shall fall within the protection scope of the present disclosure.

### Embodiment 1

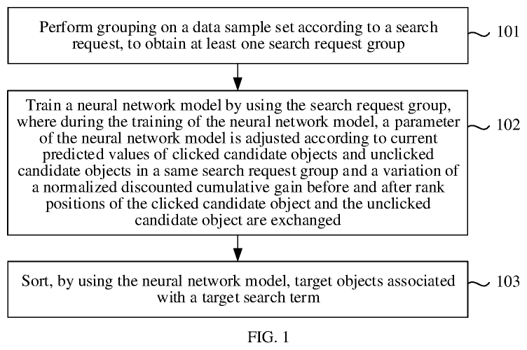

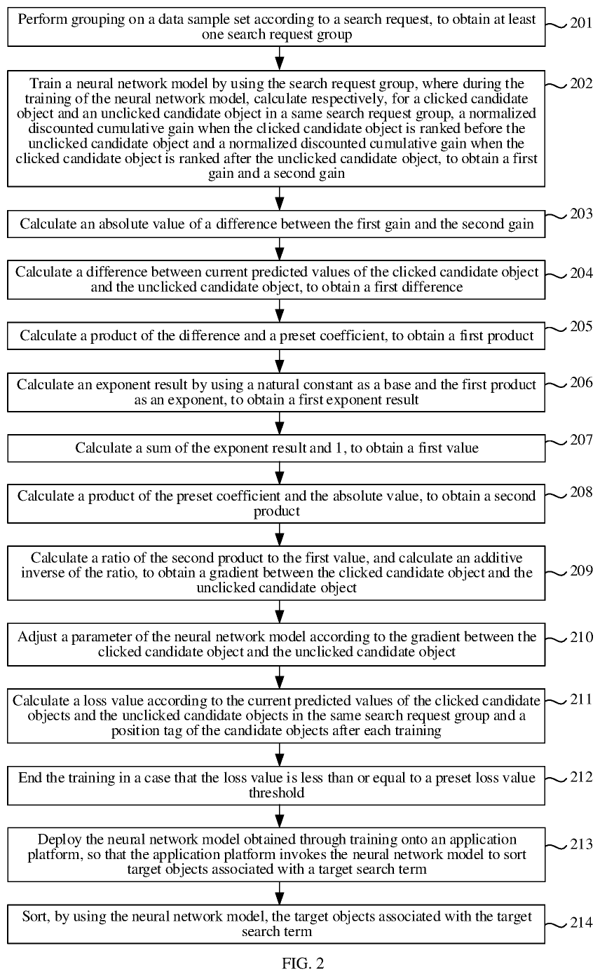

FIG. 1 shows a flowchart of specific steps of a sorting method according to the present disclosure, including the following steps:

Step 101: Perform grouping on a data sample set according to a search request, to obtain at least one search request group.

The data sample set includes a large quantity of data samples. Each data sample includes a search request identifier, a keyword inputted by a user during a search, an object related to the keyword, a flag indicating whether the object is clicked, and the like.

In an actual application, the search request identifier is a unique identifier of a search request, and a plurality of data samples having a same search request identifier correspond to a same search request. In this embodiment of the present disclosure, data samples in the data sample set may be grouped according to search request identifiers, so that data samples corresponding to a same search request belong to a same search request group.

Specifically, after the grouping, each search request group is packed.

Step 102: Train a neural network model by using the search request group, where during the training of the neural network model, a parameter of the neural network model is adjusted according to current predicted values of clicked candidate objects and unclicked candidate objects in a same search request group and a variation of an NDCG before and after rank positions of the clicked candidate object and the unclicked candidate object are exchanged.

In this embodiment of the present disclosure, the neural network model is trained by using a search request group as a unit.

The neural network model may be a deep learning model, such as a DWN model, a DFM, and a DCN model, adapted to the field of search recommendation.

Training is inputting a data sample into the neural network model to obtain a current predicted value of this training, continuously adjusting a parameter of the neural network model according to the current predicted value, and repeatedly performing prediction and parameter adjustment, to finally optimize the model. It may be understood that in an initial state, the parameter of the neural network model is random. In this embodiment of the present disclosure, training can may be implemented by using a TensorFlow framework.

An NDCG is a common indicator in a search recommendation system. The NDCG integrates two factors, namely, relevance and a position. A formula of the NDCG is already a general formula in the field of search recommendation technologies, and is not described in detail in this embodiment of the present disclosure.

Specifically, after each training ends, a gradient of each data sample is first calculated according to current predicted values of clicked candidate objects and unclicked candidate objects in a same search request group and a variation of an NDCG before and after rank positions of the clicked candidate object and the unclicked candidate object are exchanged. A parameter of the neural network model is then adjusted according to the gradient.

In this embodiment of the present disclosure, the neural network model may be adjusted with reference to the NDCG, so that an adjustment result is more adapted to the field of search recommendation and helps to improve accuracy of the neural network model.

Step 103: Sort, by using the neural network model, target objects associated with a target search term.

In the present disclosure, the neural network model obtained through the training in step 102 may be used for sorting an associated target object after each user enters a target search term in an actual application.

The target object may be a text, a video, an image, or the like.

In conclusion, this embodiment of the present disclosure provides a sorting method, including: performing grouping on a data sample set according to a search request, to obtain at least one search request group; training a neural network model by using the search request group, where during the training of the neural network model, a parameter of the neural network model is adjusted according to current predicted values of clicked candidate objects and unclicked candidate objects in a same search request group and a variation of an NDCG before and after rank positions of the clicked candidate object and the unclicked candidate object are exchanged; and sorting, by using the neural network model, target objects associated with a target search term. The neural network model may be adjusted with reference to the NDCG, so that an adjustment result is more adapted to the field of search recommendation and helps to improve accuracy of the neural network model.

### Embodiment 2

In this embodiment of the present disclosure, an optional sorting method is described.

Step 201: Perform grouping on a data sample set according to a search request, to obtain at least one search request group.

For this step, refer to detailed descriptions of step 101. Details are not described herein again.

Step 202: Train a neural network model by using the search request group, where during the training of the neural network model, calculate respectively, for a clicked candidate object and an unclicked candidate object in a same search request group, an NDCG when the clicked candidate object is ranked before the unclicked candidate object and an NDCG when the clicked candidate object is ranked after the unclicked candidate object, to obtain a first gain and a second gain.

In this embodiment of the present disclosure, for calculation formulas of the first gain and the second gain, reference may be made to the existing formulas, and no limitation is imposed in this embodiment of the present disclosure.

Step 203: Calculate an absolute value of a difference between the first gain and the second gain.

Specifically, an absolute value |Δ_{NDCG}_{_{i,j}}| of a difference between the first gain and the second gain may be calculated by referring to the following formula:

|Δ_{NDCG}_{_{i,j}}|=|NDCG_{i,j}−NDCG_{j,i}| (1)

where NDCG_{i,j} is an NDCG when a clicked candidate object i is ranked before an unclicked candidate object j, and NDCG_{j,i} is an NDCG when the clicked candidate object i is ranked after the unclicked candidate object j.

Step 204: Calculate a difference between current predicted values of the clicked candidate object and the unclicked candidate object, to obtain a first difference.

Specifically, a calculation formula of a first difference M1, is as follows:

M1_{i,j}=Sᵢ−Sⱼ (2)

where Sᵢ is a current predicted value of the clicked candidate object, and Sᵢ is a current predicted value of the unclicked candidate object.

Step 205: Calculate a product of the difference and a preset coefficient, to obtain a first product.

Specifically, a calculation formula of a first product P1_{i,j} is as follows:

P1_{i,j}=σM1_{i,j}=σ·(Sᵢ−Sⱼ) (3)

where σ is a preset coefficient, and may be set according to an actual application scenario. This is not limited in this embodiment of the present disclosure.

Step 206: Calculate an exponent result by using a natural constant as a base and the first product as an exponent, to obtain a first exponent result.

Specifically, a calculation formula of a first exponent result I1_{i,j} is as follows:

$$I {1}_{i , j} = {e}^{P {1}_{i , j}} = {e}^{σ ( {S}_{i} - {S}_{j} )} \qquad ( 4 )$$

Step 207: Calculate a sum of the exponent result and 1, to obtain a first value.

Specifically, a calculation formula of a first value V1_{i,j} is as follows:

V1_{i,j}=1+I1_{i,j}=1+e^{σ(s}^{ᵢ}^{-S}^{ⱼ}⁾ (5)

Step 208: Calculate a product of the preset coefficient and the absolute value, to obtain a second product.

Specifically, a calculation formula of a second product P2_{i,j} is as follows:

P²_{i,j}=σ|Δ_{NDCG}_{_{i,j}}| (6)

Step 209: Calculate a ratio of the second product to the first value, and calculate an additive inverse of the ratio, to obtain a gradient between the clicked candidate object and the unclicked candidate object.

Specifically, a calculation formula of a gradient λ_{i,j} between the clicked candidate object and the unclicked candidate object is as follows:

$${λ}_{i , j} = - \frac{P {2}_{i , j}}{V {1}_{i , j}} = - \frac{σ \vert {Δ}_{{NDCG}_{i , j}} \vert}{1 + {e}^{σ ( {S}_{i} - {S}_{j} )}} \qquad ( 7 )$$

Step 210: Adjust a parameter of the neural network model according to the gradient between the clicked candidate object and the unclicked candidate object.

It may be understood that the gradient may represent a variation tendency, and therefore, may be used for instructing adjustment of a parameter of a model.

In this embodiment of the present disclosure, the parameter of the model may be accurately adjusted according to the gradient.

Optionally, in another embodiment of the present disclosure, step 210 includes sub-steps 2101 to 2105:

Sub-step 2101: Obtain, for each candidate object, separately another candidate object before a position of the candidate object and another candidate object after the position of the candidate object, to obtain a first object and a second object.

In an actual application, an arrangement sequence depends on whether a candidate object is clicked. A clicked candidate object is arranged in the front, and unclicked candidate object is arranged in the back. Specially, if a clicked candidate object is labeled as 1, and an unclicked candidate object is labeled as 0, for a candidate object labeled as 1, the first object does not exist, only the second object exists; and for a candidate object labeled as 0, the second object does not exist, only the first object exists.

Certainly, the clicked candidate object may be further labeled according to a click-through rate or another indicator instructing sorting, so that the first object and the second object can be determined according to specific values of specific indicators.

Sub-step 2102: Calculate a sum of a gradient of the candidate object and a gradient of the first object, to obtain a first gradient sum.

It may be understood that for a candidate object, a first gradient sum is a gradient sum of the candidate object and another candidate object ranked before the candidate object.

Sub-step 2103: Calculate a sum of the gradient of the candidate object and a gradient of the second object, to obtain a second gradient sum.

It may be understood that for a candidate object, a second gradient sum is a gradient sum of the candidate object and another candidate object ranked after the candidate object.

Sub-step 2104: Calculate a difference between the second gradient sum and the first gradient sum, to obtain an adjustment gradient of the candidate object.

It may be understood that an adjustment gradient is a unique gradient of each candidate object, and may be used for instructing adjustment of a parameter of a model.

Sub-step 2105: Adjust a parameter corresponding to the candidate object in the neural network model according to the adjustment gradient.

Specifically, a parameter is adjusted according to the adjustment gradient.

In this embodiment of the present disclosure, all candidate objects may be integrated, to calculate an adjustment gradient, and instruct adjustment of a parameter of a model, so that the parameter of the model can be accurately adjusted, which helps to improve accuracy of the model.

Step 211: Calculate a loss value according to the current predicted values of the clicked candidate objects and the unclicked candidate objects in the same search request group and a position tag of the candidate objects after each training.

A position tag can label sequential positions of the clicked candidate object and the unclicked candidate object, and may be set according to an actual application scenario. For example, when the candidate object i is before the candidate object j, a position tag corresponding to the clicked candidate object i and the unclicked candidate object j is 1. When the candidate object i is after the candidate object j, a position tag corresponding to the clicked candidate object i and the unclicked candidate object j is 0.

In an actual application, a loss value is used for determining whether the training ends.

Optionally, in another embodiment of the present disclosure, step 211 includes sub-steps 2111 to 2118:

Sub-step 2111: Calculate, for the current predicted values of the clicked candidate objects and the unclicked candidate objects in the same search request group, a difference between 1 and the position tag of the candidate objects, to obtain a second difference.

Specifically, a calculation formula of a second difference M2_{i,j} is as follows:

M2_{i,j}=1−Sᵢⱼ (8)

where Sᵢⱼ is a position tag corresponding to the clicked candidate object i and the unclicked candidate object j.

Sub-step 2112: Calculate, for the current predicted values of the clicked candidate objects and the unclicked candidate objects in the same search request group, a difference between the current predicted values of the clicked candidate object and the unclicked candidate object, to obtain a third difference.

Specifically, a calculation formula of a third difference M3_{i,j} is as follows:

M3_{i,j}=Sᵢ−Sⱼ (9)

Sub-step 2113: Calculate a product of the second difference, the third difference, a preset coefficient, and one half, to obtain a third product.

Specifically, a calculation formula of a third product P3_{i,j} is as follows:

$$P {3}_{i , j} = \frac{1}{2} P {2}_{i , j} \cdot σ \cdot P {3}_{i , j} = \frac{1}{2} ( 1 - {S}_{ij} ) \cdot σ \cdot ( {S}_{i} - {S}_{j} ) \qquad ( 10 )$$

Sub-step 2114: Calculate a product of the third difference and the preset coefficient, and calculate an additive inverse of the ratio, to obtain a fourth product.

Specifically, a calculation formula of a fourth product P4_{i,j} is as follows:

P4_{i,j}=−M3_{i,j}·σ=−σ(Sᵢ−Sⱼ) (11)

Sub-step 2115: Calculate an exponent result by using a natural constant as a base and the fourth product as an exponent, to obtain a second exponent result.

Specifically, a calculation formula of a second exponent result I2_{i,j} is as follows:

I2_{i,j}=e^{P4}^{_{i,j}}=e^{-σ(S}^{ᵢ}^{-S}^{ⱼ}⁾ (12)

Sub-step 2116: Calculate a sum of 1 and the second exponent result as a true number, and calculate a logarithm by using 10 as a base, to obtain a logarithm result.

Specifically, a calculation formula of a logarithm result L_{i,j} is as follows:

L_{i,j}=log(1+I2_{i,j})=log(1+e^{-σ(S}^{ᵢ}^{-S}^{ⱼ}⁾) (13)

Sub-step 2117: Calculate a sum of the third product and the logarithm result, to obtain a first loss value of the clicked candidate object and the unclicked candidate object.

Specifically, a calculation formula of a first loss value C_{i,j} of the clicked candidate object i and the unclicked candidate object j is as follows:

$${C}_{i , j} = P {3}_{i , j} + {L}_{i , j} = \frac{1}{2} ( 1 - {S}_{ij} ) \cdot σ \cdot ( {S}_{i} - {S}_{j} ) + log ( 1 + {e}^{- σ ( {S}_{i} - {S}_{j} )} ) \qquad ( 14 )$$

Sub-step 2118: Calculate an average of the first loss value of the clicked candidate object and the unclicked candidate object, to obtain a loss value.

Specifically, for a combination of various clicked candidate objects and unclicked candidate objects under all search requests, a total average is calculated to obtain a loss value.

Step 212: End the training in a case that the loss value is less than or equal to a preset loss value threshold.

A loss value threshold may be set according to an actual application scenario, and is not limited in this embodiment of the present disclosure. It may be understood that when a loss value threshold is too large, a neural network model obtained through training has relatively low accuracy, but has a relatively short training time; and when a loss value threshold is too small, a neural network model obtained through training has relatively high accuracy, but has a relatively long training time. In an actual application, the loss value threshold may be set according to requirements.

In this embodiment of the present disclosure, a neural network model that uses a current parameter when the training ends may be used as a final neural network model in an actual application.

Step 213: Deploy the neural network model obtained through training onto an application platform, so that the application platform invokes the neural network model to sort target objects associated with a target search term.

An application platform may be a search recommendation platform, and in this embodiment of the present disclosure, a TensorFlow framework is used as the application platform.

Specifically, the neural network model may be packed and stored and installed on the application platform, so that when receiving a target search term, the application platform first obtains a plurality of associated target objects, and then invokes the neural network model offline, to sort the target objects.

In this embodiment of the present disclosure, a pre-trained neural network model may be deployed on the application platform and is invoked offline to perform sorting. thereby flexibly applying the neural network model.

Step 214: Sort, by using the neural network model, the target objects associated with the target search term.

For this step, refer to detailed descriptions of step 103. Details are not described herein again.

In conclusion, this embodiment of the present disclosure provides a sorting method, including: performing grouping on a data sample set according to a search request, to obtain at least one search request group; training a neural network model by using the search request group, where during the training of the neural network model, a parameter of the neural network model is adjusted according to current predicted values of clicked candidate objects and unclicked candidate objects in a same search request group and a variation of an NDCG before and after rank positions of the clicked candidate object and the unclicked candidate object are exchanged; and sorting, by using the neural network model, target objects associated with a target search term. The neural network model may be adjusted with reference to the NDCG, so that an adjustment result is more adapted to the field of search recommendation and helps to improve accuracy of the neural network model.

The embodiments of the present disclosure further provide an electronic device, including a processor, a memory, and a computer program stored in the memory and executable on the processor, where the processor, when executing the computer program, performs the sorting method of the foregoing embodiments, including:

performing grouping on a data sample set according to a search request, to obtain at least one search request group;

training a neural network model by using the search request group, where during the training of the neural network model, a parameter of the neural network model is adjusted according to current predicted values of clicked candidate objects and unclicked candidate objects in a same search request group and a variation of an NDCG before and after rank positions of the clicked candidate object and the unclicked candidate object are exchanged; and

sorting, by using the neural network model, target objects associated with a target search term.

Optionally, the step of adjusting a parameter of the neural network model according to current predicted values of clicked candidate objects and unclicked candidate objects in a same search request group and a variation of an NDCG before and after rank positions of the clicked candidate object and the unclicked candidate object are exchanged includes:

calculating respectively, for the clicked candidate object and the unclicked candidate object in the same search request group, an NDCG when the clicked candidate object is ranked before the unclicked candidate object and an NDCG when the clicked candidate object is ranked after the unclicked candidate object, to obtain a first gain and a second gain;

calculating an absolute value of a difference between the first gain and the second gain;

calculating a difference between the current predicted values of the clicked candidate object and the unclicked candidate object, to obtain a first difference;

calculating a product of the difference and a preset coefficient, to obtain a first product;

calculating an exponent result by using a natural constant as a base and the first product as an exponent, to obtain a first exponent result;

calculating a sum of the exponent result and 1, to obtain a first value;

calculating a product of the preset coefficient and the absolute value, to obtain a second product;

calculating a ratio of the second product to the first value, and calculating an additive inverse of the ratio, to obtain a gradient between the clicked candidate object and the unclicked candidate object; and

adjusting the parameter of the neural network model according to the gradient between the clicked candidate object and the unclicked candidate object.

Optionally, the gradient λ_{i,j} between the clicked candidate object and the unclicked candidate object is calculated according to the following formula:

$${λ}_{i , j} = \frac{- σ \vert {Δ}_{NDCG} \vert}{1 + {e}^{σ ( {S}_{i} - {S}_{j} )}}$$

where σ is a preset coefficient, Sᵢ and Sⱼ are respectively the current predicted values of the clicked candidate object and the unclicked candidate object, and Δ_{NDCG} is the variation of the NDCG before and after the rank positions of the clicked candidate object and the unclicked candidate object are exchanged.

Optionally, the step of adjusting the parameter of the neural network model according to the gradient between the clicked candidate object and the unclicked candidate object includes:

obtaining, for each candidate object, separately another candidate object before a position of the candidate object and another candidate object after the position of the candidate object, to obtain a first object and a second object;

calculating a sum of a gradient of the candidate object and a gradient of the first object, to obtain a first gradient sum;

calculating a sum of the gradient of the candidate object and a gradient of the second object, to obtain a second gradient sum;

calculating a difference between the second gradient sum and the first gradient sum, to obtain an adjustment gradient of the candidate object; and

adjusting a parameter corresponding to the candidate object in the neural network model according to the adjustment gradient.

Optionally, the method further includes:

calculating a loss value according to the current predicted values of the clicked candidate objects and the unclicked candidate objects in the same search request group and a position tag of the candidate objects after each training; and

ending the training in a case that the loss value is less than or equal to a preset loss value threshold.

Optionally, the step of calculating a loss value according to the current predicted values of the clicked candidate objects and the unclicked candidate objects in the same search request group and a position tag of the candidate objects includes:

calculating, for the current predicted values of the clicked candidate objects and the unclicked candidate objects in the same search request group, a difference between 1 and the position tag of the candidate objects, to obtain a second difference; and

calculating, for the current predicted values of the clicked candidate objects and the unclicked candidate objects in the same search request group, a difference between the current predicted values of the clicked candidate object and the unclicked candidate object, to obtain a third difference;

calculating a product of the second difference, the third difference, a preset coefficient, and one half, to obtain a third product;

calculating a product of the third difference and the preset coefficient, and calculating an additive inverse of the ratio, to obtain a fourth product;

calculating an exponent result by using a natural constant as a base and the fourth product as an exponent, to obtain a second exponent result;

calculating a sum of 1 and the second exponent result as a true number, and calculating a logarithm by using 10 as a base, to obtain a logarithm result;

calculating a sum of the third product and the logarithm result, to obtain a first loss value of the clicked candidate object and the unclicked candidate object; and

calculating an average of the first loss value of the clicked candidate object and the unclicked candidate object, to obtain a loss value.

Optionally, a first loss value C_{i,j} of the clicked candidate object and the unclicked candidate object is calculated according to the following formula:

$${C}_{i , j} = \frac{1}{2} ( 1 - {S}_{ij} ) σ ( {S}_{i} - {S}_{j} ) + log ( 1 + {e}^{- σ ( {S}_{i} - {S}_{j} )} )$$

where Sᵢⱼ is a difference between tag values of a clicked candidate object and an unclicked candidate object.

Optionally, before the sorting, by using the neural network model, target objects associated with a target search term, the method further includes:

deploying the neural network model obtained through training onto an application platform, so that the application platform invokes the neural network model to sort the target objects associated with the target search term.

The embodiments of the present disclosure further provide a computer program, including computer-readable code, when the computer-readable code, when executed on a computing device, causes the computing device to perform the sorting method of the foregoing embodiments.

The embodiments of the present disclosure further provide a nonvolatile computer-readable storage medium, storing the computer program of the foregoing embodiments.

The foregoing described device embodiments are merely examples. The units described as separate parts may or may not be physically separate, and the parts displayed as units may or may not be physical units, may be located in one position, or may be distributed on a plurality of network units. Some or all of the modules may be selected according to actual needs to achieve the objectives of the solutions of the embodiments. A person of ordinary skill in the art may understand and implement the solutions without creative efforts.

The various component embodiments of the present disclosure may be implemented in hardware or in software modules running on one or more processors or in a combination thereof. A person skilled in the art should understand that a microprocessor or a digital signal processor (DSP) may be used in practice to implement some or all of the functions of some or all of the components of the computing device according to the embodiments of the present disclosure. The present disclosure may alternatively be implemented as a device or apparatus program (for example, a computer program and a computer program product) for performing part or all of the methods described herein. Such a program implementing the present disclosure may be stored on a computer-readable storage medium or may have the form of one or more signals. Such signals may be downloaded from Internet websites, provided on carrier signals, or provided in any other form.

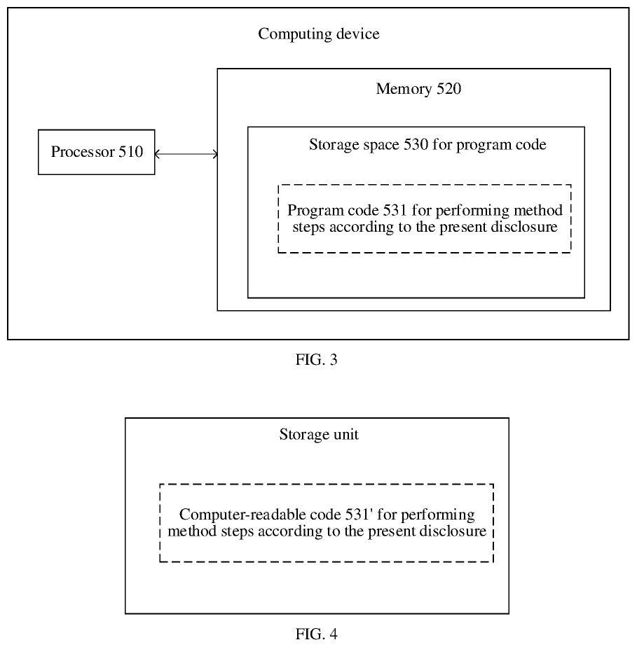

FIG. 3 illustrates a computing device that can implement the method according to the present disclosure. Conventionally, the computing device includes a processor 510 and a computer program product in a form of a memory 520 or a computer-readable storage medium. The memory 520 may be an electronic memory such as a flash memory, an electrically erasable programmable read-only memory (EEPROM), an EPROM, a hard disk, or a ROM. The memory 520 has a storage space 530 of program code 531 used for performing any method step in the foregoing method. For example, the storage space 530 for storing program code may include pieces of the program code 531 used for implementing various steps in the foregoing method. The program code may be read from one or more computer program products or be written to the one or more computer program products. The computer program products include a program code carrier such as a hard disk, a compact disc (CD), a storage card or a floppy disk. Such a computer program product is generally a portable or fixed storage unit with reference to FIG. 4. The storage unit may have a storage segment, a storage space, and the like arranged similarly to those of the memory 520 in the computing device of FIG. 3. The program code may be, for example, compressed in an appropriate form. Generally, the storage unit includes computer-readable code 531′, that is, code that can be read by a processor such as the processor 510. The code, when executed by a computing device, causes the computing device to execute the steps of the method described above.

“An embodiment”, “embodiment”, or “more or more embodiments” mentioned in the specification means that particular features, structures, or characteristics described with reference to the embodiment or embodiments may be included in at least one embodiment of the present disclosure. In addition, it should be noted that the wording example “in an embodiment” herein does not necessarily indicate a same embodiment.

Numerous specific details are set forth in the specification provided herein. However, it can be understood that, the embodiments of the present disclosure may be practiced without the specific details. In some examples, known methods, structures, and technologies are not disclosed in detail, so as not to mix up understanding on the specification.

In the claims, any reference signs placed between parentheses shall not be construed as limiting the claims. The word “comprise” does not exclude the presence of elements or steps not listed in the claims. The word “a” or “an” preceding an element does not exclude the presence of a plurality of such elements. The present disclosure can be implemented by way of hardware including several different elements and an appropriately programmed computer. In the unit claims enumerating several apparatuses, several of these apparatuses can be specifically embodied by the same item of hardware. The use of the words such as “first”, “second”, “third”, and the like does not denote any order. These words can be interpreted as names.

Finally, it should be noted that the foregoing embodiments are merely used for describing the technical solutions of the present invention, but are not intended to limit the present disclosure. It should be understood by a person of ordinary skill in the art that although the present disclosure has been described in detail with reference to the foregoing embodiments, modifications can be made to the technical solutions described in the foregoing embodiments, or equivalent replacements can be made to some technical features in the technical solutions; as long as such modifications or replacements do not cause the essence of corresponding technical solutions to depart from the spirit and scope of the technical solutions of the embodiments of the present disclosure.

1. A sorting method, comprising:
performing, by one or more processors, grouping on a data sample set according to a search request, to obtain at least one search request group;
training, by the one or more processors, a neural network model by using the search request group, wherein during the training of the neural network model, a parameter of the neural network model is adjusted according to current predicted values of clicked candidate objects and unclicked candidate objects in a same search request group and a variation of a normalized discounted cumulative gain (NDCG) before and after rank positions of the clicked candidate object and the unclicked candidate object are exchanged; and
sorting, by the one or more processors by using the neural network model, target objects associated with a target search term.

2. The method according to claim 1, wherein the step of adjusting a parameter of the neural network model according to current predicted values of clicked candidate objects and unclicked candidate objects in a same search request group and a variation of an NDCG before and after rank positions of the clicked candidate object and the unclicked candidate object are exchanged comprises:
calculating respectively, for the clicked candidate object and the unclicked candidate object in the same search request group, an NDCG when the clicked candidate object is ranked before the unclicked candidate object and an NDCG when the clicked candidate object is ranked after the unclicked candidate object, to obtain a first gain and a second gain;
calculating an absolute value of a difference between the first gain and the second gain;
calculating a difference between the current predicted values of the clicked candidate object and the unclicked candidate object, to obtain a first difference;
calculating a product of the difference and a preset coefficient, to obtain a first product;
calculating an exponent result by using a natural constant as a base and the first product as an exponent, to obtain a first exponent result;
calculating a sum of the exponent result and 1, to obtain a first value;
calculating a product of the preset coefficient and the absolute value, to obtain a second product;
calculating a ratio of the second product to the first value, and calculating an additive inverse of the ratio, to obtain a gradient between the clicked candidate object and the unclicked candidate object; and
adjusting the parameter of the neural network model according to the gradient between the clicked candidate object and the unclicked candidate object.

3. The method according to claim 2, wherein the gradient λ_{i,j} between the clicked candidate object and the unclicked candidate object is calculated according to the following formula:
$${λ}_{i , j} = \frac{- σ \vert {Δ}_{NDCG} \vert}{1 + {e}^{σ ( {S}_{i} - {S}_{j} )}}$$
wherein σ is a preset coefficient, Sᵢ and Sⱼ are respectively the current predicted values of the clicked candidate object and the unclicked candidate object, and Δ_{NDCG} is the variation of the NDCG before and after the rank positions of the clicked candidate object and the unclicked candidate object are exchanged.

4. The method according to claim 2, wherein the step of adjusting the parameter of the neural network model according to the gradient between the clicked candidate object and the unclicked candidate object comprises:
obtaining, for each candidate object, separately another candidate object before a position of the candidate object and another candidate object after the position of the candidate object, to obtain a first object and a second object;
calculating a sum of a gradient of the candidate object and a gradient of the first object, to obtain a first gradient sum;
calculating a sum of the gradient of the candidate object and a gradient of the second object, to obtain a second gradient sum;
calculating a difference between the second gradient sum and the first gradient sum, to obtain an adjustment gradient of the candidate object; and
adjusting a parameter corresponding to the candidate object in the neural network model according to the adjustment gradient.

5. The method according to claim 1, further comprising:
calculating a loss value according to the current predicted values of the clicked candidate objects and the unclicked candidate objects in the same search request group and a position tag of the candidate objects after each training; and
ending the training in a case that the loss value is less than or equal to a preset loss value threshold.

6. The method according to claim 5, wherein the step of calculating a loss value according to the current predicted values of the clicked candidate objects and the unclicked candidate objects in the same search request group and a position tag of the candidate objects comprises:
calculating, for the current predicted values of the clicked candidate objects and the unclicked candidate objects in the same search request group, a difference between 1 and the position tag of the candidate objects, to obtain a second difference; and
calculating, for the current predicted values of the clicked candidate objects and the unclicked candidate objects in the same search request group, a difference between the current predicted values of the clicked candidate object and the unclicked candidate object, to obtain a third difference;
calculating a product of the second difference, the third difference, a preset coefficient, and one half, to obtain a third product;
calculating a product of the third difference and the preset coefficient, and calculating an additive inverse of the ratio, to obtain a fourth product;
calculating an exponent result by using a natural constant as a base and the fourth product as an exponent, to obtain a second exponent result;
calculating a sum of 1 and the second exponent result as a true number, and calculating a logarithm by using 10 as a base, to obtain a logarithm result;
calculating a sum of the third product and the logarithm result, to obtain a first loss value of the clicked candidate object and the unclicked candidate object; and
calculating an average of the first loss value of the clicked candidate object and the unclicked candidate object, to obtain a loss value.

7. The method according to claim 5, wherein a first loss value C_{i,j} of the clicked candidate object and the unclicked candidate object is calculated according to the following formula:
$${C}_{i , j} = \frac{1}{2} ( 1 - {S}_{ij} ) σ ( {S}_{i} - {S}_{j} ) + log ( 1 + {e}^{- σ ( {S}_{i} - {S}_{j} )} )$$
wherein Sᵢⱼ is a difference between tag values of a clicked candidate object and an unclicked candidate object.

8. The method according to claim 1, wherein before the sorting, by using the neural network model, target objects associated with a target search term, the method further comprises:
deploying the neural network model obtained through training onto an application platform, so that the application platform invokes the neural network model to sort the target objects associated with the target search term.

9. An electronic device, comprising a memory, a processor, and a computer program stored in the memory and executable on the processor, wherein the processor performs the following operations, comprising:
performing grouping on a data sample set according to a search request, to obtain at least one search request group;
training a neural network model by using the search request group, wherein during the training of the neural network model, a parameter of the neural network model is adjusted according to current predicted values of clicked candidate objects and unclicked candidate objects in a same search request group and a variation of a normalized discounted cumulative gain (NDCG) before and after rank positions of the clicked candidate object and the unclicked candidate object are exchanged; and
sorting, by using the neural network model, target objects associated with a target search term.

10. The electronic device according to claim 9, wherein the operation of adjusting a parameter of the neural network model according to current predicted values of clicked candidate objects and unclicked candidate objects in a same search request group and a variation of an NDCG before and after rank positions of the clicked candidate object and the unclicked candidate object are exchanged comprises:
calculating respectively, for the clicked candidate object and the unclicked candidate object in the same search request group, an NDCG when the clicked candidate object is ranked before the unclicked candidate object and an NDCG when the clicked candidate object is ranked after the unclicked candidate object, to obtain a first gain and a second gain;
calculating an absolute value of a difference between the first gain and the second gain;
calculating a difference between the current predicted values of the clicked candidate object and the unclicked candidate object, to obtain a first difference;
calculating a product of the difference and a preset coefficient, to obtain a first product;
calculating an exponent result by using a natural constant as a base and the first product as an exponent, to obtain a first exponent result;
calculating a sum of the exponent result and 1, to obtain a first value;
calculating a product of the preset coefficient and the absolute value, to obtain a second product;
calculating a ratio of the second product to the first value, and calculating an additive inverse of the ratio, to obtain a gradient between the clicked candidate object and the unclicked candidate object; and
adjusting the parameter of the neural network model according to the gradient between the clicked candidate object and the unclicked candidate object.

11. The electronic device according to claim 10, wherein the gradient λ_{i,j} between the clicked candidate object and the unclicked candidate object is calculated according to the following formula:
$${λ}_{i , j} = \frac{- σ \vert {Δ}_{NDCG} \vert}{1 + {e}^{σ ( {S}_{i} - {S}_{j} )}}$$
wherein σ is a preset coefficient, Sᵢ and Sⱼ are respectively the current predicted values of the clicked candidate object and the unclicked candidate object, and Δ_{NDCG} is the variation of the NDCG before and after the rank positions of the clicked candidate object and the unclicked candidate object are exchanged.

12. The electronic device according to claim 10, wherein the step of adjusting the parameter of the neural network model according to the gradient between the clicked candidate object and the unclicked candidate object comprises:
obtaining, for each candidate object, separately another candidate object before a position of the candidate object and another candidate object after the position of the candidate object, to obtain a first object and a second object;
calculating a sum of a gradient of the candidate object and a gradient of the first object, to obtain a first gradient sum;
calculating a sum of the gradient of the candidate object and a gradient of the second object, to obtain a second gradient sum;
calculating a difference between the second gradient sum and the first gradient sum, to obtain an adjustment gradient of the candidate object; and
adjusting a parameter corresponding to the candidate object in the neural network model according to the adjustment gradient.

13. The electronic device according to claim 9, wherein the processor further operations comprising:
calculating a loss value according to the current predicted values of the clicked candidate objects and the unclicked candidate objects in the same search request group and a position tag of the candidate objects after each training; and
ending the training in a case that the loss value is less than or equal to a preset loss value threshold.

14. The electronic device according to claim 9, wherein before the sorting, by using the neural network model, target objects associated with a target search term, the method further comprises:
deploying the neural network model obtained through training onto an application platform, so that the application platform invokes the neural network model to sort the target objects associated with the target search term.

15. A non-volatile computer-readable storage medium, storing computer program code, wherein when the computer program code is executed by an electronic device, the electronic device performs the following operations:
performing grouping on a data sample set according to a search request, to obtain at least one search request group;
training a neural network model by using the search request group, wherein during the training of the neural network model, a parameter of the neural network model is adjusted according to current predicted values of clicked candidate objects and unclicked candidate objects in a same search request group and a variation of a normalized discounted cumulative gain (NDCG) before and after rank positions of the clicked candidate object and the unclicked candidate object are exchanged; and
sorting, by using the neural network model, target objects associated with a target search term.

16. The non-volatile computer-readable storage medium according to claim 15, wherein
the step of adjusting a parameter of the neural network model according to current predicted values of clicked candidate objects and unclicked candidate objects in a same search request group and a variation of an NDCG before and after rank positions of the clicked candidate object and the unclicked candidate object are exchanged comprises:
calculating respectively, for the clicked candidate object and the unclicked candidate object in the same search request group, an NDCG when the clicked candidate object is ranked before the unclicked candidate object and an NDCG when the clicked candidate object is ranked after the unclicked candidate object, to obtain a first gain and a second gain;
calculating an absolute value of a difference between the first gain and the second gain;
calculating a difference between the current predicted values of the clicked candidate object and the unclicked candidate object, to obtain a first difference;
calculating a product of the difference and a preset coefficient, to obtain a first product;
calculating an exponent result by using a natural constant as a base and the first product as an exponent, to obtain a first exponent result;
calculating a sum of the exponent result and 1, to obtain a first value;
calculating a product of the preset coefficient and the absolute value, to obtain a second product;
calculating a ratio of the second product to the first value, and calculating an additive inverse of the ratio, to obtain a gradient between the clicked candidate object and the unclicked candidate object; and
adjusting the parameter of the neural network model according to the gradient between the clicked candidate object and the unclicked candidate object.

17. The non-volatile computer-readable storage medium according to claim 16, wherein the gradient λ_{i,j} between the clicked candidate object and the unclicked candidate object is calculated according to the following formula:
$${λ}_{i , j} = \frac{- σ \vert {Δ}_{NDCG} \vert}{1 + {e}^{σ ( {S}_{i} - {S}_{j} )}}$$
wherein σ is a preset coefficient, Sᵢ and Sⱼ are respectively the current predicted values of the clicked candidate object and the unclicked candidate object, and Δ_{NDCG} is the variation of the NDCG before and after the rank positions of the clicked candidate object and the unclicked candidate object are exchanged.

18. The non-volatile computer-readable storage medium according to claim 16, wherein the step of adjusting the parameter of the neural network model according to the gradient between the clicked candidate object and the unclicked candidate object comprises:
obtaining, for each candidate object, separately another candidate object before a position of the candidate object and another candidate object after the position of the candidate object, to obtain a first object and a second object;
calculating a sum of a gradient of the candidate object and a gradient of the first object, to obtain a first gradient sum;
calculating a sum of the gradient of the candidate object and a gradient of the second object, to obtain a second gradient sum;
calculating a difference between the second gradient sum and the first gradient sum, to obtain an adjustment gradient of the candidate object; and
adjusting a parameter corresponding to the candidate object in the neural network model according to the adjustment gradient.

19. The non-volatile computer-readable storage medium according to claim 15, wherein
the operations further comprise:
calculating a loss value according to the current predicted values of the clicked candidate objects and the unclicked candidate objects in the same search request group and a position tag of the candidate objects after each training; and
ending the training in a case that the loss value is less than or equal to a preset loss value threshold.

20. The non-volatile computer-readable storage medium according to claim 15, wherein before the sorting, by using the neural network model, target objects associated with a target search term, the method further comprises:
deploying the neural network model obtained through training onto an application platform, so that the application platform invokes the neural network model to sort the target objects associated with the target search term.
